(19) United States
(12) Patent Application Publication
(10) Pub. No.: US 2015/0294088 A1
(43) Pub. Date: Oct. 15, 2015

(54) Patient Summary Generation

(71) Applicant: Cerner Innovations, LLC, Kansas city, MS (US)

(72) Inventors: James Walker, New Cumberland, PA (US); Balaji Krishnapuram, King of Prussia, PA (US); Faisal Farooq, Norristown, PA (US)

(21) Appl. No.: 14/252,950

(22) Filed: Apr. 15, 2014

(51) Int. Cl. G06F 19/00

(52) U.S. Cl. CPC G06F 19/3487; G06F 19/322; G06F 19/3431

(57) ABSTRACT

Patient summary generation may involve receiving a request for summary data relating to treatment of a patient over a period of time and accessing a medical record of the patient to determine at least one condition of the patient for the period of time. Summary generation may also involve determining reporting categories relating to the at least one condition, identifying elements of the medical records associated with the reporting categories, determining data of the identified elements indicative of the summary data for the at least one condition, and compiling the summary data into a summary report.

### FIELD OF THE INVENTION

The present embodiments relate to patient summary generation. Specifically, the present embodiments relate to patient summary generation from an electronic medical record containing data related to treatment of the patient.

### BACKGROUND

Medical entities acquire and store significant amounts of patient medical information for diagnosis, treatment, and tracking purposes. Information aggregation in a daily routine can present a significant challenge to health care practitioners and facilities. This is not only due to the quantity of information that may be captured in current healthcare environments, but also because of the complexity of the data. Further, regulatory requirements and modern medical equipment are generating more data to be stored and organized for use by medical practitioners and facilities. Historically, this information was acquired using paper forms, filled out by patients or medical entity personnel.

Recently, Electronic Medical Records (EMR) have become a standard storage technique for medical and health records for patients of medical practitioners and medical entities. EMRs contain a considerable amount of medical data for specific patients, from various sources and in various formats. Collections of EMRs for medical facilities provide medical records and history for most, if not all, patients in a medical entity.

It has been reported that a significant amount of medical practitioner's time is spent organizing, entering, and digesting information from medical record systems as it relates to patients undergoing care. Part of this time is due to the creation of summaries of care for patients that involve an analysis of a patient's medical record to determine information that is indicative of the patient's care by a facility. The amount of time required to manage documentation reduces the amount of time a practitioner may spend directly providing treatment to patients.

Summaries of care related to a patient in a medical facility may be needed for communication purposes internally at medical facilities as well as externally with other medical care providers. These summaries may be able to provide a concise snapshot of the treatment of a patient over a period of time. Typically these summaries are manually created by a medical practitioner reviewing medical information related to a patient.

The creation of patient summaries, however, may require a manual interpretation and assembly of information from a medical record of a patient by a medical practitioner. For example, a practitioner may read an entire medical record for a patient and manually type selected information into a summary report to accurately capture the treatment of the patient. This manual intervention to create summaries of care related to patients can consume significant amounts of time of medical practitioners, particularly of medical practitioners with large numbers of patients. Also, the manual review of a medical record may involve oversights or errors due to the volume of information that must be reviewed. As such, errors in care, such as incorrect or redundant procedures, may result from manual review of a medical record.

### BRIEF SUMMARY

By way of introduction, the preferred embodiments described below include methods, computer readable media, and systems for generating summaries of activities, treatments, and/or other information relating to patients. To facilitate the generation of these summaries, electronic medical records may be accessed to provide information specifically related to a patient's care at a medical facility over a period of time. Specifically, a condition of the patient may be determined and medical records corresponding to categories of medical record elements associated with the condition may be identified to provide summary data.

In a first aspect, a method is presented for patient summary generation. The method may involve receiving a request for summary data relating to treatment of a patient over a period of time, determining at least one condition of the patient for the period of time and from an Electronic Medical Record (EMR) of the patient; determining, by at least one processor, reporting categories relating to the at least one condition, identifying elements of the EMR associated with the reporting categories, determining data of the identified elements indicative of the summary data for the at least one condition, and compiling the summary data into a summary report.

In a second aspect, a system is presented for patient summary report generation. The system may involve at least one memory operable to store an Electronic Medical Record (EMR) for a patient of a medical facility. The system may also involve a processor configured to cause the system to determine at least one condition of the patient for a period of time using the EMR, determine reporting categories relating to the at least one condition, identify elements of the EHR relating to the reporting categories, determine data of the identified elements indicative of summary data for the at least one condition, and compile the summary data into a summary report.

In a third aspect, a non-transitory computer readable storage medium is provided having stored therein data representing instructions executable by a programmed processor for generation of a patient summary report. The storage medium may involve instructions for receiving a request for a patient summary report regarding a period of time a patient was being treated at a medical facility, determining at least one condition of the patient from an Electronic Medical Record (EMR) for the period of time, identifying elements of the EMR associated with one or more reporting categories related to the at least one condition, the reporting categories selected at least in part based on the period of time, and compiling a summary of values of the variables into the patient summary report.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a representation of an electronic medical record.

FIG. 2 is a flow chart diagram of one embodiment of a method for patient summary generation;

FIG. 3 is a block diagram of one embodiment of a system for patient summary generation; and

FIG. 4 is an illustration of a system for patient summary report generation.

### DETAILED DESCRIPTION OF THE DRAWINGS AND PRESENTLY PREFERRED EMBODIMENTS

Electronic medical records (EMR) may be accessed using a system designed to support and speed up a medical practitioner's decision making by leveraging the EMR data along with other medical data sources to provide context-sensitive highlighting and presentation of relevant clinical information. The system may involve providing information in a manner so as to support the momentary information focus that a medical practitioner may allocate when organizing or summarizing patient medical data. The system may involve the automated extraction and presentation of aggregated longitudinal patient information, such as diseases, allergies, and medications relating to care of a patient. The system may also involve automated recommendations and/or options for care based on reference knowledge, similar cases, and/or specialized expert knowledge that may, for example, indicate potential adverse drug interactions. For example, contact information for a medical specialist may be provided. Further, the system may automatically organize and/or summarize patient data for a practitioner. Generally, the system may access multiple health data sources to provide a holistic view of the patient with a focus on specific aspects of a patient relevant to specific practitioners at specific times during the care for the patient.

A summary of activities related to a patient may be generated automatically using an EMR of the patient. The elements used for the generation of the summary, or summary report, may be created automatically throughout different parts of a system as specific procedures are performed on a patient during the course of care. The results of these procedures are recorded in the EMR of the patient. Through an analysis of the EMR a condition, such as diabetes, may be determined for patient. Over a period of time, multiple results and records of activity will be stored in the EMR of the patient. These multiple results and records may then be assimilated and reconciled through an automated process into a summary report for the patient. The summary report summarizes the results and/or records representing the patient over the period of time. The data from the EMR chosen for inclusion in the summary report may be associated with the condition determined for a patient. Further, the summary report may be presented to a medical practitioner for confirmation or correction of the data represented in the report.

The summary report may be a summary of a visit for a patient to a medical facility. For example, lab values and vital statistics for a particular trip to a facility may be provided. Further, the summary report may be a summary presenting relevant information of a lifetime of medical records for a patient in a succinct and easy to understand manner. The summary report may be dynamic and change as data is updated or added to a system. The summary report may also be practitioner role focused by providing what is relevant to the specific role for whom the report is produced. For example, a patient summary report generated by or for a nurse may be different than a patient summary report generated by or for a physician. In this way, practitioners achieve a time savings and are provided with a snapshot of required patient related information very quickly, thus saving practitioners time and facility resources. Further, as the reports may be automatically generated by a system, the possibility of omissions or oversights due to the volume of information is reduced. Ultimately, the system may provide better, more accurate summary reports, in a shorter amount of time, while still providing a practitioner access to the complete medical record to verify, adjust, investigate, and/or finalize the report.

Summary reports may be for specific time periods or at specific times of care. As an example, after a physician prescribes a medication to a patient, a nurse may document the order and then document the administration of this medication in an EMR. Data relating to these activities may be extracted and summarized in a type of summary report known as progress note. For example, once the order is received in an order entry system, the receipt can be used to trigger creation of a snippet of a progress note where the order is documented. After the pharmacy fulfills the order in the pharmacy system, an additional snippet can be added to the progress note. After the nurse receives the medication (e.g. IV antibiotic) on the floor and administers the medication, this activity is captured in the EMR at the nurse's station. This can again be used to trigger the creation of a text snippet and appended to the progress note. Ultimately, all activity relating to the patient over a period of time may be reflected in the assimilated progress note. Further, the activities included in the progress note may be chosen as activities associated with the diagnosis or treatment of a condition.

In another example, a discharge summary may be created. Discharge summaries may be summary reports relating to a time period for treatment of a patient at a medical facility from admission to discharge. Discharge summaries may involve rules for formatting, inclusion, and presentation of data. These rules may include standard sections or collections of sections in templates. Discharge summaries may have sections for past medical history, history of present illness, home medications, discharge medications, hospital course of treatment, as well as other sections relating to the medical history or condition of the patient. Also, custom templates, or assemblies of sections, for discharge summaries for patients being treated for the top conditions (e.g. top 20), which account for most hospital admissions, may be available. Specific sections may be included or excluded based on a determined condition.

Sections to be included in a discharge report may be filled automatically or semi-automatically using data from an EMR of the patient. For example, a patient may enter an emergency department with chest pain. A triage nurse may quickly fill out a computer based form for medical history of the patient. The medical history is saved in the EMR. This information is then passed on to a floor nurse, who may document additional information, or correct existing information in the EMR. The EMR may also be reviewed, updated, or corrected by the floor attending physician. Once these steps are completed, these entries may automatically be used to create a past medical history section of the discharge summary for the patient.

In an embodiment, information may be assimilated from various systems (e.g. emergency, lab, or pharmacy departments) that are generating inputs from various practitioners in the overall care team or involved in facilitating a course of treatment (e.g. emergency nurse, floor nurse, physicians, pharmacists, lab technicians, or specialists). The system then takes the most relevant information for a particular type of summary document (e.g. a progress note, discharge summary, or shift report) and then creates snippets of text or structured elements in a database automatically for the purpose of documentation. The content and structure of these snippets may change dynamically based on the disease, condition, user, or other factors relating to a requested or required summary. In this way, data included in summaries may be created in a distributed manner both physically by data entry in different physical locations, and structurally by medical professionals in different roles relating to patient care. Summary reports may then be generated by assimilating the information entered from various inputs of the care team and from different systems in the organization.

Data from an EMR included in summary reports may be dependent on a condition determined for a patient. Data determined relevant for appropriate characterization of the diagnosis or treatment of a condition may be included in the summary report, whereas data from an EMR determined not relevant may be excluded from the summary report.

The creation of relevant sections (e.g. key results, specific problems) may also include natural language processing to understand, extract, summarize, normalize and codify information present in different systems and different formats. Further, the generation of summaries may also include generation of natural language from keywords and structured information present in tables, forms, or other data structures of an EMR.

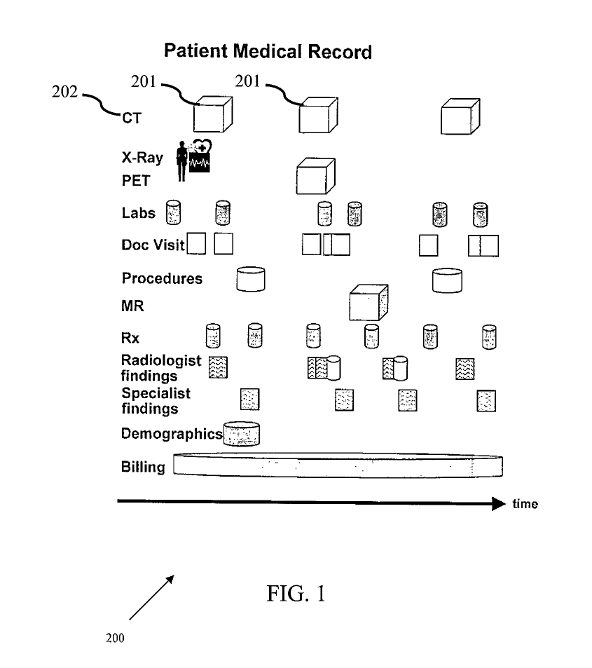

FIG. 1 shows an exemplary EMR 200. Health care providers may employ automated techniques for information storage and retrieval. The use of an EMR to maintain patient information is one such example. As shown in FIG. 1, an exemplary EMR 200 includes information collected over the course of a patient's treatment or use of an institution. The information may be collected using forms, form templates, form sections, or combinations thereof. The information may be input into the EMR by any method including both automatic insertion and update through system data updating, or manual insertion or creation of data by health care professionals. For example, information entry may be may be nurses, physicians, or technicians of a medical facility. The information may include, for example, computed tomography (CT) images, X-ray images, laboratory test results, doctor progress notes, details about medical procedures, prescription drug information, radiological reports, other specialist reports, demographic information, family history, patient information, and billing (financial) information. Any of this information may provide for information related to a potential condition for a patient and be presented as summary data.

An EMR may include a plurality of data sources, each of which typically reflects a different aspect of a patient's care. Alternatively, the EMR is integrated into one data source. Structured data sources, such as financial, laboratory, and pharmacy databases, generally maintain patient information in database tables. Information may also be stored in unstructured data sources, such as, for example, free text, images, and waveforms. Often, characteristics, such as key clinical findings, are stored within unstructured physician reports, annotations on images or other unstructured data source. In an embodiment, unstructured data may involve natural language text provided in a free text field. For example, a free text field may have stored free text in an Ejection Fraction field such as “patient LV ejection fraction of 60 percent is considered normal.”

An EMR may include categories 202 such as CT images as well as specific elements 201 which would include specific CT images in the CT images category. Also, multiple categories 202 may be considered categories. For example, both the CT images and X-ray images may be considered an image category. In an embodiment, categories 202 in an EMR may be considered reporting categories for summary data regarding a condition of a patient. Elements 201 of the reporting categories may be identified, and the elements may have data indicative of summary data relating to the condition of the patient. This data may be extracted and compiled into a summary report.

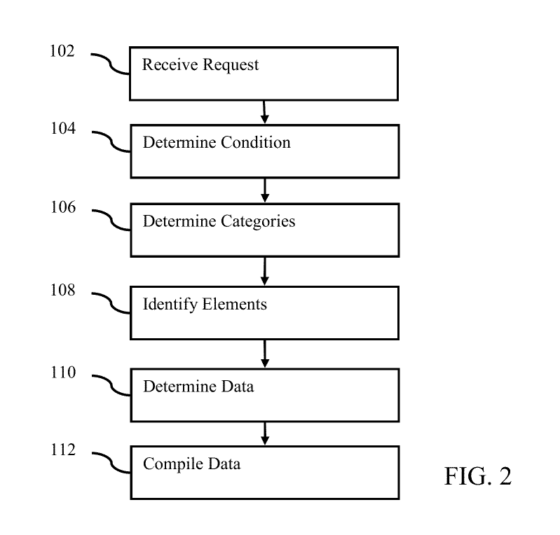

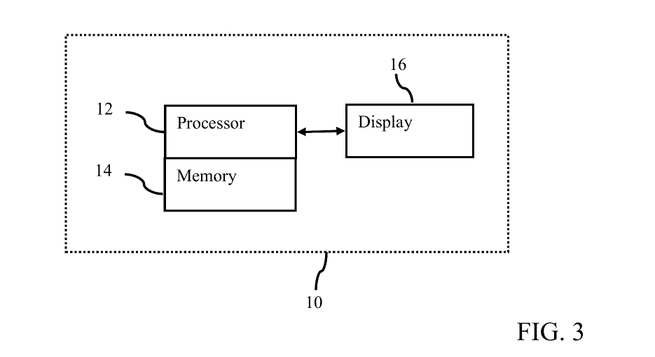

FIG. 2 shows a flow chart diagram of one embodiment of a method for patient summary generation. The method is implemented by a computerized physician order entry (CPOE) system, an automated workflow system, a review station, a workstation, a computer, a picture archiving and communication system (PACS) station, a server, combinations thereof, or other system in a medical facility. For example, the system and/or computer readable media shown in FIG. 3 implements the method, but other systems may be used.

Additional, different, or fewer acts may be performed. For example, an act for generating a report from summary data may be provided. In another example, act 102 may be omitted. The method is implemented in the order shown or a different order. For example, acts 104, 106, 108, and/or 110 may be performed in parallel or repeated.

In act 102, a request for summary data relating to treatment of a patient may be received. The request may relate to treatment of the patient over a period of time or may specifically indicate a period of time for the summary data. Any period of time may be used, such as a specific length of time or an amount of time between specific events. The period of time may include a current time (e.g., summary of patient history up until the time at which the summary is to be generated).

Summary data may be any data related to a condition that is identified as relaying pertinent information regarding the condition. For example, data useful or mandatory for diagnosis or characterization of a condition may be considered summary data, such as body temperatures for a patient determined to have an infection. Summary data may be further processed or manipulated into various forms prior to or during the compiling act 112 described below.

In an embodiment, a request may be generated by a user of a system as is described with respect to FIG. 3. A user may be any practitioner or person operating a system. For example, a user may be a physician, nurse, medical technician, or any other medical professional using the system. In an embodiment, the request may originate remote from the performance of the acts described herein. For example, the request may originate from a separate room in the same facility, or on a different continent, and be communicated to a system performing the acts.

A request may be manually or automatically generated. A request may be manually generated by a user inputting a patient and/or specifying a time period for the summary data. In an embodiment, a system may automatically detect a patient and/or a time period associated with a user. For example, a nurse may be logged into a workstation. The workstation may have access to a list of active patients for the nurse. The workstation may select a most recently active or updated patient EMR of the active patients, and generate a request for summary data for the patient associated with that EMR. Further, the system may have access to a scheduled log of the current shift for a nurse, and identify a time period for summary data relating to that shift.

In act 104, a condition of the patient may be determined. The condition may be a condition of the patient for the period of time. Further, multiple conditions may be determined.

Conditions may be determined using any method. For example, a condition may be specifically and/or explicitly indicated in an EMR or input by a user. Conditions may also be determined automatically. Automatic determination of conditions may be performed by an analysis of information in an EMR. The analysis may be any analysis of electronic records capable of determining a condition for a patient. In an embodiment, the analysis involves the application of a machine learned model to the electronic records. For example, a Bayesian Network model trained using a Markov Chain Monte Carlo (MCMC) method may be used. In another example, a model based on the Expectation Maximization method may be used. The machine learned model may be trained using knowledge of an expert, or documented prior knowledge such as ontologies or medical databases. The model relates possible inputs or existing records as a feature vector for a patient to one or more possible conditions.

A condition may involve any condition for a patient. In an embodiment, a determined condition involves a medical condition of the patient. For example, a condition may be heart disease, diabetes, epilepsy, hepatitis B, an allergy, or any condition related to the health or status of a patient. The condition is a possible diagnosis. A given input feature vector may indicate only one or more than one possible diagnoses and corresponding conditions.

In an embodiment, a probability that a patient has a condition is determined. The determined probability may be compared to a probability threshold. If the probability meets a threshold, it is determined that the condition applies to a patient. For example, a probability threshold may be 75% probability that a condition applies to a patient. Any determined probability larger than 75% indicates that the condition applies to a patient. Any probability scoring system may be used. The machine learnt model may be probabilistic so as to output a probability associated with one or more conditions.

In an embodiment, a probabilistic network may be used to determine possible conditions for a patient. The probabilistic network may have connections between terms or concepts and associated conditions represented by probabilities indicating that a current patient may have a condition. The probabilities may represent a current state of knowledge or data for a patient, and may be updated with inputs of additional information.

Multiple conditions may be determined to apply to a patient. A given model may provide more than one condition. Alternatively, different models, such as models specific to one or more conditions are applied to the data for the patient. Different models may test for different conditions.

In an embodiment, condition determination may be iterative. Information may be added to an EMR during the course of care for a patient. Analysis of the EMR may be re-performed using the added or updated information to identify more specific conditions or other conditions of a patient. The condition for a patient may change, such as switching from one to another or adding a condition that was not previously assigned to the patient. Numerous inputs of information and condition determinations may be generated during an iterative process of summary generation.

In act 106, reporting categories are determined. The reporting categories relate to the conditions determined for a patient. The reporting categories involve types of procedures or information related to the treatment or diagnosis of a condition. The records of the specific procedures or information are organized as elements, and as such, categories may be considered to be collections of specific and similarly characterized elements. Elements are described in more detail below with respect to act 108. Further, categories may involve a broad characterization of types of procedures or data. For example, if influenza is a determined condition, internal temperatures and prescribed medications may be categories where data may be pertinent to the determined condition. From this it can be seen that categories may include multiple types of input data. For example, an internal temperature may be only recorded using one method for adults, however, in infants body temperatures may be reported as rectal temperatures, under-arm temperatures, or even skin surface temperatures indicative of an internal temperature. All of these techniques may be stored as separate data or elements in separate fields of a medical record, but would all exist within an internal temperature category. Also, different medications may be given to a patient at different times for different reasons throughout a period of care. All these medication related entries or elements may be considered a medication category. This may be further evidenced by the existence of various imaging, such as magnetic resonance imaging or X-ray imaging, and other diagnostic or treatment techniques which generate different data or elements, but may be considered within a same category.

In an embodiment, categories may be specifically associated with conditions. The association may exist in a structured relational table or database, or as an associative probabilistic model. Further, an EMR may contain individual elements, such as treatments or procedure records that relate to these categories.

Further, categories may be selected by a user. For example, a standard set of categories may be presented to a user and the user may choose or select specific categories. Further, a user may change the categories of a standard category to be presented to the specific user during system use.

In an embodiment, categories may be based on a period of time specified for the summary data. For example, if the period of time is short, such as a period of several hours relating to a shift at a medical facility, categories may be selected that adequately reflect the actions taken with regard to the patient during those hours. Categories such as clothing changes or catheter verifications may be considered summary categories given a condition determined for a patient. Contrarily, such categories may not be deemed relevant for a summary of a time period encapsulating a patient's entire time of are at a facility. In such a report, clothing changes or catheter verifications may not be deemed summary categories of data, but other categories such as a general daily status notes from a physician may be deemed an indicative and appropriate summary data category for the period of time. Time periods may be arranged based on thresholds to determine categories relevant to time periods. For example, a time period relating to 8 hours or less may include a selection of categories, whereas a time period from 8-24 may include different categories.

In act 108, elements of an EMR associated with the reporting categories may be identified. Elements may be records of specific tests, procedures, notations, or other elements relating to a patient. The EMR may be the EMR of the patient receiving treatment. For example, a condition of head trauma may be indicated for a patient. Categories such as head imaging may be associated with a head trauma condition. Specific elements of an EMR such as magnetic resonance images and/or x-ray images may be considered part of a head imaging category and identified. Values for variables, graphs, charts, images, or other data relevant for any one of the categories identified from the condition of a given patient is queried or obtained from the EMR. Further, as described more fully below with respect to act 110, elements may be considered to be collections of data or values relating to and describing the element. Some data of elements may be appropriate for summary data, and other data of the same element may not.

In an embodiment, the elements are associated with categories explicitly. Elements may be associated with categories using any technique. For example, elements may be listed in a relational table with associated category names or indications. To illustrate, an element such as a magnetic resonance image may be associated with an imaging category. Included in the imaging category may be other elements, such as X-ray images.

In act 110, summary data may be determined. Summary data may be determined from data of the identified elements of an EMR. Elements may contain data representing values or results of procedures or other medical tasks. For example, an internal temperature element may contain data indicating a time the temperature was taken, the value of the temperature, the method of taking the temperature, the equipment used to take the temperature, or any other data relating to the internal temperature element. Any of the element data may be determined to be summary data. Elements of an EMR may contain significant amounts of data. In some circumstances, only some of the data of an element is considered summary data for a determined category. For example, specific fields, values, or sections of an element in an EMR may be summary data for an element as related to the determined condition. In an embodiment, elements of an EMR may be analyzed to determine data indicative of summary data. For example, an element indicating a blood test of the patient may include values associated with the blood test indicative of blood test results. These blood test results may be considered summary data. In another example, an X-ray element may have notes associated, and the notes may be identified as, or as containing, summary data.

Also, as single elements may include many different measurements or data, some of these measurements and data may be considered summary data relating to a condition, while other measurements and data of an element may not. Further, some data of an element may be considered summary data for one condition, and other data of the same element may be considered summary data for a different condition. For example, blood glucose levels of a blood test may be considered as relevant to treatment and diagnosis of a diabetes condition and thus be determined as summary data from a blood test element. However, other values in a blood test such as high-density lipoprotein (HDL) cholesterol levels may not be considered summary data for a diabetes condition. In another example, magnetic resonance or x-ray images may have physician or radiologist notes associated with the images. These notes may be indicative of summary data for determined head trauma conditions. Other notes included with the imaging element may relate to general observations of the image and not specifically to head trauma, and thus not be considered summary data.

In an embodiment, identified elements may be presented to a user for a selection of elements from which to determine data indicative of summary data. For example, a user may be presented with all identified elements, and a user may select the elements desired for the summary report data. These selected elements may then be analyzed to determine summary data, whereas the unselected elements may not be analyzed.

Types and instances of summary data may be specifically associated with different conditions. For example, specific fields of elements in an EMR containing data that is recognized as summary data for a condition may be associated with that condition. The association may be literal, as in an associative table, or probabilistic as in a probabilistic model applied to subject matter relating to a condition.

In an embodiment, an EMR may be mined to determine and/or extract summary data for reporting. Any data mining may be used, such as is disclosed in U.S. Pat. No. 7,617,078, the disclosure of which is incorporated herein by reference. Different sources of data for a given category or element may be identified and any discrepancies resolved. Different values of a same variable (e.g., category itself or of a category or element) may be detected. The values may be combined using inference or assigned probabilities from a knowledge base to determine a final value for the variable. Final values may be determined for any number of variables or elements for a given category. The final value or values are used as the identified or determined summary data.

Structured or unstructured data may be used to provide summary data. Unstructured data may be stored in a free text field. For example, a free text field may have stored free text in an Ejection Fraction field such as “patient LV ejection fraction of 60 percent is considered normal.” From this text, “60”, “LV”, and “ejection fraction” may be considered summary data. This summary data may be identified as indicating a 60 percent Ejection Fraction for the left ventricle of a patient. As such natural language may be processed and analyzed for content of summary data. Any natural language or free text processing may be used to determine summary data.

In act 112, the summary data may be compiled. The summary data may be compiled into any form, for example a summary report may be generated.

In an embodiment, the summary report may have associated with it a summary report type. Report types may involve formatting or summary data selection that varies between report types.

In an embodiment, a system may further involve determining a summary report type. For example, a report type may be an admission report covering a time period involving the admission of a patient into a facility, a shift report relating to a time period of a practitioner's shift in charge of a patient for a facility, a discharge report covering the time from admission to discharge of a patient, or any other report corresponding to a typical time range. A report type may be determined through a manual selection, or automatically. In an embodiment, an automatic determination may at least in part be made based on the period of time indicated for the summary data. For example, a time period corresponding to an admission and a discharge of a patient may be determined to be a discharge report type.

In an embodiment, the summary report type may be associated with users of the system or categories of users of a system. For example, a physician may have associated report types that indicate different summary data than report types associated with a nurse. Further, particular users may also have customized report types associated with the particular user.

In an embodiment, rules may be associated with report types. For example, a discharge report may have a rule indicating that only one internal temperature value per day is provided for a patient, whereas a shift report may list every temperature value recorded for a patient during the time period. Further, compiling the summary data may involve compiling the summary data into a summary report conforming to rules established for a report type. The report type may be used to guide the identification and mining so that desired summary data is obtained.

In an embodiment, a time period indicated for summary data may be compared to a set of thresholds to determine a report type. For example, a period of 8 hours or less may be indicative of a shift report type.

Summary data may also be included with other data upon compilation. In an embodiment, summary data may be extracted as values, such as temperatures, and compiled into a report with other supporting data, such as natural language prose. For example, a patient temperature of 98.7 degrees may be presented in a report with supporting text data so as to read, “The patient had an internal temperature of 98.7 degrees.” Multiple pieces of summary data may be combined using supporting data. For example, a time of a temperature reading may correspond to a time proximate to the admission of the patient to a facility. The compilation of this data with the temperature summary data may result in text data such as, “The patient was admitted to the emergency room with an internal temperature of 98.7 degrees.” In such a statement, the text strings “was admitted”, “emergency room”, and “98.7 degrees” may each be derived from summary data, and the rest of the text may be considered supporting data for the summary data. Both supporting data and summary data may be presented in a summary report. In this way, natural language statements may be generated and presented with summary data in a manner familiar to a user or intended recipient of a summary data. Further, supporting data may be specific to types of summary data or standardized for summary reports or summary report types.

Summary data may involve data relating to procedures that are performed repetitively on a patient during a course of care for a patient. These repetitive procedures may be periodic, or requested and performed multiple times throughout a period of time. Compiling summary data may involve identifying these repetitive procedures and determining a way to alternatively present this summary data. Alternate summary data presentations may involve any type of alternate presentation that adequately represents the summary data. In an embodiment, summary statistics regarding these procedures may be presented. For example, a discharge report type may involve a care period for a patient of multiple days. Over these multiple days, values for an internal temperature of the patient may be recorded in an EMR of the patient for every three hours during the care period. The number of readings, and the values of the specific readings, may not be deemed useful for summary data, whereas indicative statistics for the temperature values, such as a daily average, may be more indicative of the required summary data. These summary statistics may replace the specific values for summary data in a summary report.

Other forms of presentation for repetitive procedures may also be provided. For example, summary charts or graphs indicating the values in a visual form may be presented.

In an embodiment, multiple conditions may be determined for a patient. Accordingly, compiling the summary data may involve compiling the summary data into separate reports for each of the multiple conditions. Alternatively, a user may be prompted to select from a list of determined conditions which conditions should be included in a summary report. A user may also be prompted as to whether the summary data for multiple conditions should be compiled into a singular report or multiple reports. In an embodiment, summary data that would be common to multiple determined conditions is collected into a section of a report, and summary data not common to multiple conditions may be presented in respective condition specific sections of a report.

In an embodiment involving an iterative process of summary generation, summaries may be created and/or maintained continuously during the care of a patient. The summaries may be updated with current information input into the EMR of a patient. Summaries may available for presentation to a user at any time. The entire process may be repeated for a given repetition. Alternatively, changes to the EMR are recorded or logged and only summary data that may be altered by such a change is recalculated or recreated for a later repetition.

Patient summary generation may be provided in a manner as described herein so as to minimize the required interaction of a physician or other medical practitioner. A practitioner may be provided with a compiled summary report, already possessing information deemed relevant to a patient's care over a period of time. A practitioner may only be required to enter minimal information, such as a patient identifier or a time period, and required information may automatically be extracted. A verification or investigative process for the summary report may involve a practitioner being provided access to a full EMR of the patient, but the initial extraction and compilation of the pertinent information is performed with minimal time requirements for the practitioner. As such, a minimized time period is required for the focus of the practitioner so as to allow for an efficient use of the practitioner's time. For example, an examiner may enter a request for summary information for a specific patient over a specific time period in act 102. Subsequent to this request, a system, such as a system 10 described with respect to FIG. 3, may determine a condition for a patient, determine categories associated with the condition, identify elements of the categories for reporting, determine data of the elements suitable for summary data, and compile the summary data into a summary report for the practitioner without further interaction by the practitioner. From this provided report, a practitioner may review or modify the compiled data, but the cumbersome initial identification and extraction of data has been performed for the practitioner.

FIG. 3 shows a system 10 for patient summary generation. The system 10 is a server, network, workstation, computer, database, or combinations thereof. The system 10 includes a processor 12, a memory 14, and a display 16. Additional, different, or fewer components may be provided. For example, the system includes a scanner, a network connection, a wireless transceiver or other device for receiving patient information and/or communicating patient information to other systems.

The memory 14 is a buffer, cache, RAM, removable media, hard drive, magnetic, optical, database, or other now known or later developed memory. The memory 14 is a single device or group of two or more devices. The memory 14 is shown within the system, but may be outside or remote from other components of the system, such as a database or PACS memory.

The memory 14 stores EMRs for patients and other medical data relating to conditions of patients of a medical facility. Models, such as probabilistic graphical models trained using medical data may also be stored on the memory 14. Multiple EMRs of other patients may also be stored on the memory 14.

The memory 14 is additionally or alternatively a non-transitory computer readable storage medium with processing instructions. The memory 14 stores data representing instructions executable by the programmed processor 12 for patient summary generation. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

In an embodiment, the instructions may include receiving a request for summary data relating to treatment of a patient over a period of time, accessing an EMR of the patient to determine at least one condition of the patient for the period of time, determining reporting categories relating to the at least one condition, identifying data of the EHR associated with the reporting categories, determining identified data that is indicative of summary data for the at least one condition, and compiling the summary data into a summary report.

The processor 12 is a server, general processor, digital signal processor, graphics processing unit, application specific integrated circuit, field programmable gate array, digital circuit, analog circuit, combinations thereof, or other now known or later developed device for medical category determination. The processor 12 is a single device, a plurality of devices, or a network. For more than one device, parallel or sequential division of processing may be used. Different devices making up the processor 12 may perform different functions, such as a handwriting detector by one device and a separate device for communicating or processing the detected handwritten data. In one embodiment, the processor 12 is a control processor or other processor of a computerized data entry system for an EMR storage or database system. The processor 12 operates pursuant to stored instructions to perform various acts described herein.

The processor 12 is configured by software and/or hardware for patient summary generation. The processor 12 may be configured to cause a system 10 to access an EMR of a patient to determine at least one condition of the patient for a period of time, determine reporting categories relating to the at least one condition, identify elements of the EHR relating to the reporting categories, determine data of the identified elements indicative of summary data for the at least one condition, and compile the summary data into a summary report.

The display 16 is a CRT, LCD, plasma, projector, printer, or other output device for showing an image. The display 16 displays a user interface with an image. The user interface may be for the entry of information, such as information that may be saved in electronic records stored on the memory 14. The user interface may be for entering information into an EMR, selecting categories or elements of an EMR, or displaying summary data such as a summary report.

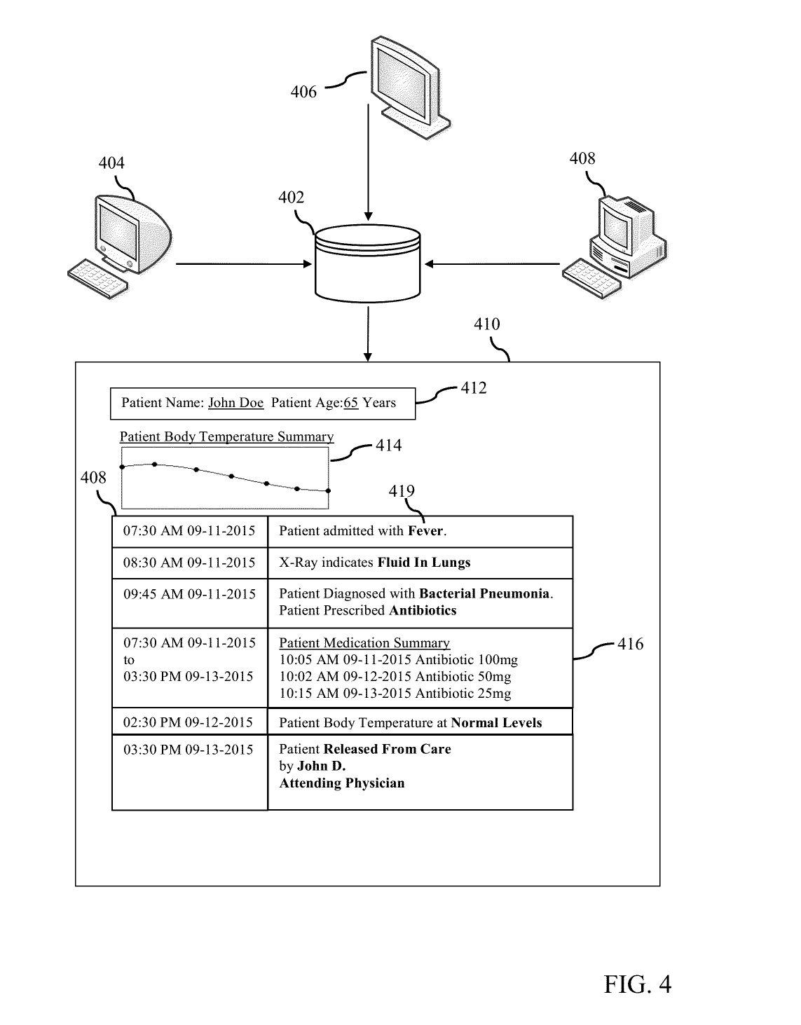

FIG. 4 is an illustration of a system for patient summary report generation. A patient may enter a medical facility emergency room and indicate to a triage practitioner that he is not feeling well. Once admitted, procedures and data may be recorded in elements of an electronic medical record, and the elements may be organized into categories. Recorded data for the elements may take any form and be input at different locations. For example, factual data relating to the patient, such as name and age, may be entered into an emergency room workstation 404. Subsequent procedures related to diagnosis of the patient may be performed in the actual emergency room, with the results being entered as data into elements using a different workstation 406. For example, temperatures may be taken of the patient at various times and entered into the workstation 406. A diagnosis of the patient may be made in the emergency room and a treatment plan may be put into place. For example, rest and medication may be prescribed by a physician. The patient may be admitted to a general care section of the facility, and the treatment plan may be carried out. For example, the application of medication and the taking of temperatures may be recorded using a workstation 408 in a room dedicated to the care of the patient. At the completion of the care plan, the patient's status may be evaluated, and the patient may be released from the facility. This information may also be tracked at various locations throughout a facility as input by various practitioners involved in the care of the patient. The inputs from the various workstations 404, 406, 408 may be accumulated into an EMR for the patient stored in a central server 402.

The central server 402 may be accessed using any workstation 404, 406, 408 to generate a summary report 410 relating to the care of the patient. The central server 402 may involve any collection of data and applications used to access the data. For example, data access layers, collections of EMR, or other sources of health data may be included in the central server 402. Also, the central server may have access to external sources of medical knowledge, such as external ontologies, that may be used in combination with the local collection of data and applications. Available medical knowledge may involve data related to diagnoses of conditions, medical procedures, anatomy, physiology, medically prescribed drugs, illicitly used drugs, poisons, viruses, bacteria, or any other data related to medical diagnosis or treatment of patients. Further, the data may be adjusted or configured to account for regional variations in care or diagnosis, as well as colloquial language variations for a particular deployment. All data and applications stored and accessed by the central server 402 may be organized using a knowledge processing and linking engine that creates applicable associations between segments of the knowledge. Further, the central server 402 may involve a workflow or activity control engine operational to schedule, track, and assign tasks and or procedures undertaken by a medical facility or medical practitioners. The central server, 402 may function as an independent operational system, or may be integrated with existing systems so as to provide the required operational functionality.

The workstations 404, 406, 408 may be any workstation, such as a desktop client, a mobile device, a browser application running on a laptop computer, or any other computing device, for example as described with respect to FIG. 3.

The summary report 410 may be generated by determining a condition of a patient from an EMR for the patient. For example, it may be explicitly stated in an element of the EMR corresponding to a physician's diagnosis that the patient has Bacterial Pneumonia. Further, a request for the summary report may include a time period for the summary. For example, a three day period corresponding to a time period from admission to release of the patient may be selected. The time period in combination with determined condition may indicate categories of data to select for the summary report. For example, the time period may indicate that the summary report is a discharge report for the patient, and as data from categories such as general patient data 412, initial admission 409, initial reporting symptoms 419, and release status 418 may be selected. Elements of an EMR pertaining to determined categories may be analyzed to provide data for the summary report 410.

Data relating to condition associated categories may also be included. For example, for a condition of Bacterial Pneumonia, data from a temperature category 414 and a medication category 416 may be extracted from the EMR and presented in the summary report 410.

Also, data may be extracted from the EMR and transformed into a format more suitable for summary data. For example, patient body temperatures 414 may be presented in chart form and medication admissions may be assembled into a summary table.

Also, categories may be indicated from the condition, but only certain elements of the category may be determined suitable for a summary report 410. For example, a patient with bacterial pneumonia may be prescribed multiple medications in a treatment plan, however only the elements of an EMR indicating an administration of antibiotics may be deemed relevant. Summary data of these elements may then be identified and extracted to provide in the summary report 410.

Ultimately, the summary report 410 may be provided to a practitioner to verify, modify, or investigate the data contained therein. This practitioner approval activity may occur, or be required to occur, prior to any activity being undertaken in response to the summary report 410.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. A method for patient summary generation, the method comprising:
receiving a request for summary data relating to treatment of a patient over a period of time;
determining at least one condition of the patient for the period of time and from an Electronic Medical Record (EMR) of the patient;
determining, by at least one processor, reporting categories relating to the at least one condition;
identifying elements of the EMR associated with the reporting categories;
determining data of the identified elements indicative of the summary data for the at least one condition; and
compiling the summary data into a summary report.

2. The method of claim 1, further comprising:
determining a summary report type based at least in part on the period of time; and
wherein the compiling comprises compiling the summary data into the summary report conforming to rules established for the report type.

3. The method of claim 2, wherein the report type is an admission report, a shift report, or a discharge report.

4. The method of claim 2, wherein the determining the summary report type is further based on a type of user associated with the request.

5. The method of claim 1, wherein the at least one condition comprises a plurality of conditions.

6. The method of claim 1, further comprising:
presenting the identified elements to a user for selection of elements; and
wherein determining data comprises determining data of the selected elements.

7. The method of claim 1, wherein compiling the summary data comprises identifying data relating to a repetitive procedure and providing an alternate summary presentation of the repetitive procedure.

8. A system for patient summary report generation, the system comprising:
at least one memory operable to store an Electronic Medical Record (EMR) for a patient of a medical facility; and
a processor configured to cause the system to:
determine, from the EMR of the patient, at least one condition of the patient for a period of time;
determine reporting categories relating to the at least one condition;
identify elements of the EMR relating to the reporting categories;
determine data of the identified elements indicative of summary data for the at least one condition; and
compile the summary data into a summary report.

9. The system of claim 8, wherein the processor is further configured to cause the system to determine a summary report type based at least in part on the period of time.

10. The system of claim 9, wherein the processor is further configured to cause the system to compile the summary data into the summary report such that the summary report conforms to at least one rule established for the report type.

11. The system of claim 10, wherein the report type is an admission report, a shift report, or a discharge report.

12. The system of claim 9, wherein the processor is further configured to cause the system to determine the summary report type based on a type of user associated with the request.

13. The system of claim 8, wherein the at least one condition comprises a plurality of conditions.

14. The system of claim 13, wherein the processor is further configured to cause the system to compile the summary data for the plurality of conditions into separate reports for each of the determined plurality of conditions.

15. The system of claim 8, wherein the processor is further configured to cause the system to:
present the identified elements to a user for selection of elements; and
determine data of the selected elements indicative of summary data for the at least one condition.

16. The system of claim 8, wherein the processor is further configured to cause the system to compile the summary data by identifying data relating to a repetitive procedure and provide summary statistics of the repetitive procedure as at least part of the summary data.

17. A non-transitory computer readable storage medium having stored therein data representing instructions executable by a programmed processor for generation of a patient summary report, the storage medium comprising instructions for:
receiving a request for a patient summary report regarding a period of time a patient was being treated at a medical facility;
determining at least one condition of the patient from an Electronic Medical Record (EMR) for the period of time;
identifying elements of the EMR associated with one or more reporting categories related to the at least one condition, the reporting categories selected at least in part based on the period of time; and
compiling a summary of values of the variables into the patient summary report.

18. The medium of claim 17, wherein the instructions are further executable by a programmed processor for:
determining a summary report type based at least in part on the period of time; and
wherein the compiling comprises compiling the summary of values into the patient summary report conforming to rules established for the report type.

19. The medium of claim 18, wherein the report type is an admission report, a shift report, or a discharge report.

20. The medium of claim 17, wherein the instructions are further executable by a programmed processor for presenting options for a report type to a user; and
wherein the compiling comprises compiling the summary of values into the patient summary report conforming to rules established for the report type.

21. The medium of claim 17, wherein the at least one condition comprises a plurality of conditions.

22. The medium of claim 21, wherein the instructions are further executable by a programmed processor for compiling the summary data for the plurality of conditions into separate reports for each of the determined plurality of conditions.
